(19) United States
(12) Patent Application Publication
(10) Pub. No.: US 2026/0209539 A1
(43) Pub. Date: Jul. 23, 2026

(54) INK

(71) Applicant: KYOCERA DOCUMENT SOLUTIONS INC., OSAKA (JP)

(72) Inventors: KENTARO OKINAKA, OSAKA (JP); KOTATSU KAWAGUCHI, OSAKA (JP); KATSUKI OSANISHI, OSAKA (JP); HIROKA ITANI, OSAKA (JP); MOTOKI SUZUKI, OSAKA (JP); SHUN KANDA, OSAKA (JP); YUSUKE WASHINO, OSAKA (JP)

(21) Appl. No.: 19/450,674

(22) Filed: Jan. 15, 2026

(30) Foreign Application Priority Data
Jan. 20, 2025 (JP) 2025-007845

(51) Int. Cl. C09D 11/38; C09D 11/033; C09D 11/102

(52) U.S. Cl. CPC C09D 11/38; C09D 11/033; C09D 11/102

(57) ABSTRACT

An ink includes: a self-dispersing pigment; 0.40 mass % or more and 5.0 mass % or less of a resin having a glass transition temperature of −40° C. or more and 30° C. or less; a first water-soluble organic solvent including a polyethylene glycol having a number average molecular weight of 200 or more and 600 or less; a second water-soluble organic solvent including triethanolamine; a third water-soluble organic solvent different from the first water-soluble organic solvent and the second water-soluble organic solvent; and water. A content of the first water-soluble organic solvent is 7.0 mass % or more and 20 mass % or less. A content of the second water-soluble organic solvent is 0.10 mass % or more and 2.0 mass % or less.

### CROSS-REFERENCE TO RELATED PATENT APPLICATION

This application claims the benefit of Japanese Priority Patent Application JP 2025-007845 filed on Jan. 20, 2025, the entire contents of which are incorporated herein by reference.

### FIELD OF THE DISCLOSURE

The present disclosure relates to an ink for forming an image by an inkjet method.

### BACKGROUND OF THE DISCLOSURE

An inkjet recording apparatus forms an image on a recording medium such as paper by repeatedly ejecting small droplets of ink from a nozzle onto the recording medium. In the recording medium such as paper formed of a fiber, a phenomenon (curling) in which the formation of an image by ink causes partial expansion and contraction of fibers, resulting in a warped shape, is likely to occur. In this regard, there has been known a technology that blends polyethylene glycol in ink in order to prevent curling from occurring.

### SUMMARY OF THE DISCLOSURE

In order to achieve the above-mentioned object, an ink according to an embodiment of the present disclosure includes: a self-dispersing pigment; 0.40 mass % or more and 5.0 mass % or less of a resin having a glass transition temperature of −40° C. or more and 30° C. or less; a first water-soluble organic solvent including a polyethylene glycol having a number average molecular weight of 200 or more and 600 or less; a second water-soluble organic solvent including triethanolamine; a third water-soluble organic solvent different from the first water-soluble organic solvent and the second water-soluble organic solvent; and water. A content of the first water-soluble organic solvent is 7.0 mass % or more and 20 mass % or less. A content of the second water-soluble organic solvent is 0.10 mass % or more and 2.0 mass % or less.

### DETAILED DESCRIPTION OF THE EXEMPLARY EMBODIMENTS

In inks in which a polyethylene glycol is blended, the viscosity increases, which leads to difficulty in ejection due to drying in the nozzle of a recording head, i.e., an intermittent ejection property is difficult to ensure. Further, in inks in which a polyethylene glycol is blended, the density of the image formed on the recording medium tends to be reduced, and the ink tends to adhere to the paper output roller of the inkjet recording apparatus, causing a phenomenon (offset) in which the subsequent recording medium is stained via the paper output roller to easily occur.

In view of the circumstances as described above, it is an object of the present disclosure to provide an ink capable of suppressing the occurrence of curling and offset and ensuring an intermittent ejection property and redispersibility.

An embodiment of the present disclosure will be described.

### [Configuration of Ink]

### (Schematic Configuration)

The ink according to the embodiment of the present disclosure includes: a self-dispersing pigment; a resin; a first water-soluble organic solvent; a second water-soluble organic solvent; a third water-soluble organic solvent; and water. The first water-soluble organic solvent includes a polyethylene glycol having a number average molecular weight of 200 or more and 600 or less. The second water-soluble organic solvent includes triethanolamine. The third water-soluble organic solvent includes a water-soluble organic solvent different from the first water-soluble organic solvent and the second water-soluble organic solvent. The ink according to this embodiment is typically a water-based ink that is ejected from a recording head of an inkjet recording apparatus onto a recording medium to form an image on the recording medium. The recording medium on which an image is to be formed by the ink according to this embodiment includes a fiber such as a cellulose fiber. Examples of such a recording medium include plain paper, copy paper, recycled paper, thin paper, and thick paper.

In the ink according to this embodiment, by blending the first water-soluble organic solvent including polyethylene glycol having a number average molecular weight of 200 or more, it is possible to suppress the occurrence of curling of the recording medium. Further, in this ink, by limiting the number average molecular weight of polyethylene glycol constituting the first water-soluble organic solvent to 600 or less, it is possible to ensure an intermittent ejection property. Further, in this ink, the effect of the first water-soluble organic solvent that causes offset to easily occur is counteracted by blending the resin having a glass transition temperature of −40° C. or more and 30° C. or less. In addition, in this ink, the effect of the resin having a glass transition temperature of −40° C. or more and 30° C. or less that deteriorates redispersibility is counteracted by blending the second water-soluble organic solvent including triethanolamine. In this way, in the ink according to this embodiment, it is possible to suppress the occurrence of curling and offset and ensure an intermittent ejection property and redispersibility. Details of each component of the ink according to this embodiment will be described below.

### (Self-Dispersing Pigment)

The self-dispersing pigment blended in the ink according to this embodiment is a pigment to which hydrophilic groups are directly or indirectly bonded to the surface by physical surface treatment or chemical surface treatment. The self-dispersing pigment imparts desired image density to the formed image.

Examples of the hydrophilic group on the particle surface of the self-dispersing pigment include, but not particularly limited to, one or more types of hydrophilic groups represented by chemical formulae selected from the group consisting of —OM, —COOM, —CO—, —SO₃M, —SO₂M, —SO₂NH₂, —RSO₂M, —PO₃HM, —PO₃M₂, —SO₂NHCOR, —NH₃, and —NR₃. In the chemical formulae, M represents a hydrogen atom, an alkali metal, ammonium, a phenyl group that may be substituted with a substituent group, or organic ammonium. R represents an alkyl group having 1 or more and 12 or less carbon atoms, or an aryl group having 1 or more and 12 or less carbon atoms, which may be substituted with a substituent group. Examples of the aryl group include a phenyl group and a naphthyl group.

Among these, an anionic functional group is favorable as the hydrophilic group. That is, as the self-dispersing pigment, an anionic self-dispersing pigment having an anionic functional group on its surface is favorable.

The anionic functional group is not particularly limited as long as it is a functional group that is negatively charged in an aqueous medium. Examples such an anionic functional group include a carboxy group, a sulfonic acid group, a phosphonic acid group, and a phosphoric acid group. Note that the anionic functional group may form a salt (e.g., an ammonium salt and a metal salt) with a cation.

The self-dispersing pigment can be prepared by causing a pigment having no self-dispersibility to be subjected to known physical surface treatment or chemical surface treatment. Examples of the physical surface treatment include vacuum plasma treatment. Examples of the chemical surface treatment include wet oxidation treatment involving oxidation with an oxidizing agent in water and treatment involving bonding p-aminobenzoic acid to the pigment surface (in this treatment, the carboxy group is bound to the pigment surface via a phenyl group).

As the self-dispersing pigment, commercial products can also be used. Examples of the commercial products of the self-dispersing pigment include CAB-O-Jet (registered trademark) series (e.g., CAB-O-Jet (registered trademark) 200, 300, 400, 250C, 260M, 270Y, 450C, 465M, 470Y, and 480M) and IJX series (e.g., IJX-157, 253, 266, 273, 444, and 55) manufactured by Cabot Corporation, BONJET (registered trademark) series (e.g., BONJET (registered trademark) CW-1, CW-1S, CW-2, and CW-3) manufactured by ORIENT CHEMICAL INDUSTRIES CO., LTD., and Aqua-Black (registered trademark) series (e.g., Aqua-Black (registered trademark) 001 and 162) manufactured by Tokai Carbon Co., Ltd.

Examples of the pigment that is a raw material of the self-dispersing pigment (pigment having no self-dispersibility) include a yellow pigment, an orange pigment, a red pigment, a blue pigment, a purple pigment, and a black pigment. Examples of the yellow pigment include C.I. Pigment Yellow (1, 2, 3, 12, 13, 14, 16, 17, 55, 73, 74, 75, 83, 93, 95, 97, 98, 109, 110, 114, 120, 128, 129, 138, 139, 150, 151, 154, 155, 173, 180, 185, and 193).

Examples of the orange pigment include C.I. Pigment Orange (34, 36, 43, 61, 63, and 71).

Examples of the red pigment include C.I. Pigment Red (5, 7, 12, 48, 48 (more specifically 48:1), 57, 112, 122, 123, 146, 168, 184, and 202).

Examples of the blue pigment include C.I. Pigment Blue (1, 2, 3, 15 (more specifically 15:3 and 15:4), 16, 22, and 60).

Examples of the purple pigment include C.I. Pigment Violet (19, 23, 33, and 1960).

Examples of the black pigment include No. 2300, No. 900, MCF88, No. 33, No. 40, No. 45, No. 52, MA7, MA8, MA100, No. 2200B, and the like manufactured by Mitsubishi Chemical Corporation, Raven (registered trademark) (5750, 5250, 5000, 3500, 1255, and 700) and the like manufactured by Columbia Chemical Corporation, conductive carbon black such as Regal (registered trademark) (400R, 330R, and 660R), Mogul (registered trademark) L, Monarch (registered trademark) (700, 800, 880, 900, 1000, 1100, 1300, and 1400), BLACK PEARLS (registered trademark) 2000, VULCAN (registered trademark) XC-72, VULCAN (registered trademark) P, and STERLIB (registered trademark) C manufactured by Cabot Corporation, and carbon black such as Color Black (FW1, FW2, FW2V, FW18, FW200, S150, S160, and S170), Printex (registered trademark) (35, U, V, and 140U), Special Black (4, 4A, 5, and 6), and the like manufactured by Orion Engineered Carbons S.A.

In the ink according to this embodiment, the content of the self-dispersing pigment is favorably 3 mass % or more and 12 mass % or less, more favorably 4 mass % or more and 8 mass % or less. In the ink according to this embodiment, by setting the content of the self-dispersing pigment to 3 mass % or more, it becomes easier to form an image with desired image density. In the ink according to this embodiment, by setting the content of the self-dispersing pigment to 12 mass % or less, it is possible to ensure fluidity of the ink according to this embodiment.

### (Resin)

The resin blended in the ink according to this embodiment is fine particles formed of a resin having a glass transition temperature of −40° C. or more and 30° C. or less. Note that in this embodiment, the “fine particle” refers to a particle having a particle diameter of 300 nm or less. In the ink according to this embodiment, the content of the resin is 0.40 mass % or more and 5.0 mass % or less. In the resin according to this embodiment, by setting the glass transition temperature to −40° C. or more and 30° C. or less, it is possible to suppress the occurrence of offset. Further, in the resin according to this embodiment, by setting the glass transition temperature to 30° C. or less, favorable deposition properties of the image on the recording medium can be achieved even if it is dried at low temperatures.

Examples of the resin blended in the ink according to this embodiment include SUPERFLEX 420 (Tg: −10° C.), SUPERFLEX 420NS (Tg: −10° C.), SUPERFLEX 460 (Tg: −21° C.), SUPERFLEX 460S (Tg: −28° C.), SUPERFLEX 470 (Tg: −31° C.), SUPERFLEX 500M (Tg: −39° C.), SUPERFLEX 740 (Tg: −34° C.), and SUPERFLEX 460S (Tg: −28° C.) manufactured by DKS Co. Ltd., and Mowinyl 6718 (Tg: 3° C.), Mowinyl 6750 (Tg: 0° C.), Mowinyl 6751D (Tg: −32° C.), Mowinyl 6760 (Tg: 0° C.), Mowinyl 6770 (Tg: 0° C.), Mowinyl 6960 (Tg: −28° C.), Mowinyl 6963 (Tg: −26° C.), Mowinyl 6775 (Tg: 5° C.), and Mowinyl 7523 (Tg: 25° C.) manufactured by Japan Coating Resin Co., Ltd.

### (First Water-Soluble Organic Solvent)

The first water-soluble organic solvent blended in the ink according to this embodiment is a polyethylene glycol having a number average molecular weight of 200 or more and 600 or less. Further, in the ink according to this embodiment, the content of the first water-soluble organic solvent is 7.0 mass % or more and 20 mass % or less. In the ink according to this embodiment, by blending 7.0 mass % or more of the first water-soluble organic solvent having a number average molecular weight of 200, it is possible to suppress the occurrence of curling. Further, in the ink according to this embodiment, by limiting the number average molecular weight of the polyethylene glycol constituting the first water-soluble organic solvent to 600 or less, it is possible to ensure an intermittent ejection property.

### (Second Water-Soluble Organic Solvent)

The second water-soluble organic solvent blended in the ink according to this embodiment is triethanolamine. The second water-soluble organic solvent is blended as a pH adjuster. In the ink according to this embodiment, the content of the second water-soluble organic solvent is 0.10 mass % or more and 2.0 mass % or less. In the ink according to this embodiment, by setting the content of the second water-soluble organic solvent to 0.10 mass % or more, it is possible to achieve high redispersibility. Further, in the ink according to this embodiment, by setting the content of the second water-soluble organic solvent to 2.0 mass % or less, it is possible to achieve a high intermittent ejection property.

### (Third Water-Soluble Organic Solvent)

The third water-soluble organic solvent blended in the ink according to this embodiment is a water-soluble organic solvent blended separately from the first water-soluble organic solvent and a second water-soluble organic solvent. Examples of the third water-soluble organic solvent include a glycol compound other than the first water-soluble organic solvent, a glycol ether compound, a lactam compound, a nitrogen-containing compound, an acetate compound, thiodiglycol, glycerin, and dimethylsulfoxide.

Examples of the glycol compound other than the first water-soluble organic solvent include ethylene glycol, 1,3-propanediol, propylene glycol, 1,3-butanediol, 2-methyl-1,3-propanediol, 1,5-pentanediol, 1,2-octanediol, 1,8-octanediol, 3-methyl-1,5-pentanediol, diethylene glycol, triethylene glycol, tetraethylene glycol, and a polyethylene glycol having a number average molecular weight of more than 600 and 1000 or less.

Examples of the glycol ether compound include diethylene glycol diethyl ether, diethylene glycol monobutyl ether, ethylene glycol monomethyl ether, ethylene glycol monobutyl ether, diethylene glycol monomethyl ether, diethylene glycol monoethyl ether, diethylene glycol diethyl ether, triethylene glycol monomethyl ether, triethylene glycol monoethyl ether, triethylene glycol monobutyl ether, and propylene glycol monomethyl ether.

Examples of the lactam compound include 2-pyrrolidone and N-methyl-2-pyrrolidone.

Examples of the nitrogen-containing compound include 1,3-dimethylimidazolidinone, formamide, and dimethylformamide.

Examples of the acetate compound include diethylene glycol monoethyl ether acetate.

Among these, triethylene glycol, tetraethylene glycol, and a polyethylene glycol having a number average molecular weight of more than 600 and 1000 or less are more favorable.

In the ink according to this embodiment, the content of the third water-soluble organic solvent is favorably 2 mass % or more and 20 mass % or less, more favorably 5 mass % or more and 15 mass % or less.

### (Water)

In the ink according to this embodiment, ion exchanged water, purified water, distilled water, or the like can be used as water. In the ink according to this embodiment, in order to achieve relatively low viscosity, the content of water is favorably 60.0 mass % or more and 90.0 mass % or less.

### (Other Components)

In the ink according to this embodiment, components other than the above may be blended as necessary. For example, in the ink according to this embodiment, a surfactant may be blended. The surfactant has the effect of enhancing the wettability of the ink on a recording medium and the effect of enhancing the compatibility and dispersion stability of each component included in the ink. Examples of the surfactant blended in the ink according to this embodiment include an anionic surfactant, a cationic surfactant, a non-ionic surfactant, and an amphoteric surfactant. As the surfactant blended in the ink according to this embodiment, a non-ionic surfactant is favorable. Among these, an acetylene glycol surfactant is particularly favorable.

Further, in the ink according to this embodiment, various additives such as a dissolution stabilizer, an anti-drying agent, an antioxidant, a viscosity adjustor, a pH adjuster, a neutralizer, and an antifungal agent may be blended as necessary in addition to the above.

### [Method of Producing Ink]

### (Schematic Configuration)

A method of producing the ink according to this embodiment includes, for example, a kneading step of kneading a self-dispersing pigment and a resin to obtain a kneaded product, a pulverization step of pulverizing the kneaded product to obtain a pigment particle, a dispersion step of dispersing the pigment particle in a solvent to obtain a pigment particle dispersion liquid, and an ink preparation step of adding a first water-soluble organic solvent, a second water-soluble organic solvent, and a third water-soluble organic solvent to the pigment particle dispersion liquid to prepare an ink.

### (Kneading Step)

This step involves kneading a self-dispersing pigment, a resin, and a different component (e.g., a basic compound) as necessary to obtain a kneaded product.

In this step, for example, the self-dispersing pigment, the resin, and the different component as necessary are mixed, and then, the mixture is kneaded using a kneading apparatus. Examples of the method of mixing the self-dispersing pigment, the resin, and the different component include a method of stirring with a mixer.

In this step, a known kneading apparatus capable of kneading a mixture having high viscosity and a high solid content ratio is used. Examples of the kneading apparatus include a kneader, a Banbury mixer kneader, a single screw extruder/kneader, and a twin screw extruder/kneader. As the kneading apparatus, a twin screw extruder/kneader is favorable.

The mixing conditions are, for example, a rotational speed of 1000 rpm or more and 3000 rpm or less and a mixing time of 1 minute or more and 10 minutes or less. The kneading conditions are, for example, a shaft rotation speed of 100 rpm or more and 200 rpm or less and a cylinder temperature of 100° C. or more and 200° C. or less.

### (Pulverization Step)

This step involves cooling the kneaded product obtained in the kneading step and pulverizing it using a pulverizer to obtain a pigment particle including the resin and the self-dispersing pigment. Examples of the pulverization method include pulverizing with a screen pulverizer. The obtained pulverized product may be used as a pigment particle as it is. Further, the above-mentioned pulverized product may be further finely pulverized using a jet mill or the like and then classified using a classifier before being used as a pigment particle.

### (Dispersion Step)

This step involves placing the pigment particle obtained in the pulverization step into a dispersing apparatus with a solvent such as ion exchanged water to perform dispersion treatment. As the dispersing apparatus, a known dispersing apparatus may be used. Examples of such a dispersing apparatus include a media disperser, a high-pressure emulsifier, an ultrasonic disperser, a high-pressure disperser, a dissolver that performs dispersion by causing special stirring blades to rotate at high speed, a disperser, a high-speed impeller disperser, Despa Mill that performs dispersion by shear force when passing through the minute gap between a rotor and a stator, TORNADO, a microblender, a cavitron, and a homomixer. As the dispersing apparatus, a high-pressure emulsifier is favorable.

In the case of using a high-pressure emulsifier, the treatment conditions may be, for example, a treatment temperature of 150° C. or more and 180° C. or less, a treatment pressure of 80 MPa or more and 250 MPa or less, and the number of passes of 3 or more and 10 or less. The treatment by the dispersing apparatus may be performed a plurality of times by combining two or more types of apparatuses.

In the pigment particle dispersion liquid obtained in the dispersion step, the content of the pigment particle is favorably 4.0 mass % or more and 25 mass % or less, more favorably 5.0 mass % or more and 20 mass % or less.

The volume median diameter (D50) of the pigment particle in the pigment particle dispersion liquid in the dispersion step is, for example, 60 μm or more and 130 μm or less.

In this step, an aqueous medium may be further added to the obtained pigment particle dispersion liquid to adjust the concentration. Further, in this step, coarse particles may be separated from the pigment particle dispersion liquid using methods such as centrifugation and filtering. In the case of performing centrifugation, the centrifugation conditions may be, for example, a centrifugal acceleration of 10,000 G or more and 21,000 G or less and a treatment time of 3 minutes or more and 15 minutes or less. Removing coarse particles by centrifugation treatment allows the dispersibility of the pigment particle in the pigment particle dispersion liquid to be improved.

### (Ink Preparation Step)

Next, the pigment particle dispersion liquid and first to third water-soluble organic solvents are mixed using a stirrer to prepare an ink. Note that in this step, a different component (more specifically, at least one of a surfactant, a dissolution stabilizer, a moisturizing agent, a penetrating agent, or a viscosity adjustor) may be further added and mixed as necessary. The obtained mixed solution is filtered as necessary. In this way, an ink is obtained.

### EXAMPLES AND COMPARATIVE EXAMPLES

As Examples and Comparative Examples of the present disclosure, inks were prepared and evaluated. Note that the following Examples are merely examples of the present disclosure, and the configuration of the present disclosure is not limited to those in Examples.

### (Preparation of Ink)

In Examples and Comparative Examples, inks were prepared by the above production method.

### (Evaluation Method)

For the inks according to Examples and Comparative Examples, an intermittent ejection property, redispersibility, and difficulty in the occurrence of offset and curling were evaluated.

### Evaluation Device

For evaluating an intermittent ejection property and difficulty in the occurrence of offset and curling, a prototype evaluation device manufactured by KYOCERA Document Solutions Inc. was used as an inkjet recording apparatus, and “KJ4B-QA” manufactured by KYOCERA Document Solutions Inc. was used as a recording head.

### Method of Evaluating Intermittent Ejection Property

The inside of the recording head was kept at 25° C. and the intermittent ejection property was evaluated in an environment of 10° C. and 15% RH. Specifically, for each ink, a first line image was formed on the recording medium by the recording head, and then, a second line image similar to the first line image was formed after passing through a non-image forming region where no image is formed. Then, whether or not the second line image is distorted was determined by microscopic observation. For each ink, a maximum value M (mm) of the dimension in the conveying direction of the non-image forming region where the second line image is not distorted was obtained, and the numerical value (=100×(M/420)) corresponding to the maximum value M when the dimension of A3 size in the longitudinal direction (420 mm) was 100 was used as an evaluation value for the intermittent ejection property. Using the evaluation value, evaluation was performed in accordance with the following criteria A and B. Inks with the evaluation of A for the intermittent ejection property are evaluated to “Pass”, and inks with the evaluation of B are evaluated to “Fail”.
A: 100 or more
B: less than 100

### Redispersibility

A petri dish containing 2 g of each ink was set in a constant-temperature chamber and held at 40° C. for 72 hours. Ion exchanged water was added dropwise to each ink after holding at a rate of 5 ml/sec. When 10 seconds have elapsed since the adding dropwise, whether or not the pigment particle in each ink was dispersed in the solvent was visually observed. On the basis of the observation results, evaluation was performed in accordance with the following criteria A and B. Inks with the evaluation of A for the redispersibility are evaluated to “Pass”, and inks with the evaluation of B are evaluated to “Fail”.
A: the pigment particle is dispersed in water
B: the pigment particle is not dispersed in water.

### Method of Evaluating Difficulty in Occurrence of Offset

First, the recording head located closest to the paper output roller in the evaluation device was filled with ink, and the excess liquid flowing onto the nozzle surface was wiped off using a wiping blade. In the evaluation device, the distance between the nozzle surface of the recording head and the recording medium was fixed to 1 mm, and the conveying speed of the recording medium from the paper feed roller to the paper output roller was set to 846.7 mm/sec. As the recording medium, “IJW” manufactured by Oji Paper Co., Ltd., which was cut to A4 size, was used. The amount of ink applied from the recording head to the recording medium was set to 15 g/m², and a 10 cm×10 cm solid image was continuously formed on 10 recording media using the evaluation device. For the 10th recording medium, the region (offset region) that is likely to be stained by the ink adhered to the paper output roller was read using an image scanner (“GT-X820” manufactured by Seiko Epson Corp.) and binarized at a threshold value of 220. An offset area ratio (%) (=100×the number of black pixels/the total number of pixels) was calculated from the number of black pixels and the total number of pixels of the binarized image, and the calculated offset area ratio was used as an evaluation value for the difficulty in the occurrence of offset. Using the evaluation value, evaluation was performed in accordance with the following criteria A and B as criteria for whether or not stains on the recording medium caused by offset are visually observed. Inks with the evaluation of A for the difficulty in the occurrence of offset are evaluated to “Pass”, and inks with the evaluation of B are evaluated to “Fail”.
A: 0.030% or less
B: exceeding 0.030%.

### Method of Evaluating Difficulty in Occurrence of Curling

The ejection amount of ink per ejection in each nozzle of the recording head was set to 11 μL, and a 10 cm×10 cm solid image was formed on a recording medium (“C2” manufactured by FUJIFILM Business Innovation Corp. (A4 size)). Immediately after that, the recording medium on which the solid image was formed was placed on the upper surface of a horizontal stand such that the solid image of the recording medium and the upper surface of the horizontal stand face each other. Then, the heights of the recording medium at the four corners from the upper surface of the horizontal stand were measured, and the average value of the heights of the recording medium at the four corners was used as an evaluation value for the difficulty in the occurrence of curling. Using the evaluation value, evaluation was performed in accordance with the following criteria A and B as criteria for whether or not the recording medium can be adsorbed for forming an image on the second side (back side) in double-sided printing when a suction fan of 0.8 KPa is used to perform suction and adsorption via a conveyor belt and straighten the recording medium using a decurling mechanism. Inks with the evaluation of A for the difficulty in the occurrence of curling are evaluated to “Pass”, and inks with the evaluation of B are evaluated to “Fail”.
A: 20 mm or less
B: exceeding 20 mm

### Examples 1 to 9

In Examples 1 to 9, a self-dispersing pigment, a resin, a first water-soluble organic solvent, a second water-soluble organic solvent, a third water-soluble organic solvent, a surfactant, and water were used to prepare inks such that the composition shown in Table 1 was achieved. Note that the units of the numerical values shown in Table 1 are “mass %”. In all of Examples 1 to 9, BONJET CW-4 manufactured by ORIENT CHEMICAL INDUSTRIES CO., LTD. was used as the self-dispersing pigment, SUPERFLEX 420 (glass transition temperature Tg: −10° C.) manufactured by DKS Co. Ltd. was used as the resin, polyethylene glycol 400 (PEG400, a number average molecular weight: approximately 400, manufactured by Tokyo Chemical Industry Co., Ltd.) was used as the first water-soluble organic solvent, triethanolamine (manufactured by Tokyo Chemical Industry Co., Ltd.) was used as the second water-soluble organic solvent, 3-methyl-1,5-pentanediol was used as the third water-soluble organic solvent, and SURFYNOL 420 (manufactured by Nissin Chemical Co., Ltd.) that is an acetylene glycol surfactant was used as the surfactant.

TABLE 1

| | Component | | | | | | |
|---|---|---|---|---|---|---|---|
| | | | Water-soluble | | | | |
| | | | organic solvent | | | | |
| Example | Pigment | Resin | First | Second | Third | Surfactant | Water |
| 1 | 8.0 | 2.0 | 15 | 1.0 | 10 | 0.50 | Remainder |
| 2 | 8.0 | 0.40 | 7.0 | 0.10 | 20 | 0.50 | Remainder |
| 3 | 8.0 | 0.40 | 20 | 0.10 | 5.0 | 0.50 | Remainder |
| 4 | 8.0 | 0.40 | 20 | 2.0 | 5.0 | 0.50 | Remainder |
| 5 | 8.0 | 0.40 | 7.0 | 2.0 | 20 | 0.50 | Remainder |
| 6 | 8.0 | 2.0 | 7.0 | 0.10 | 15 | 0.50 | Remainder |
| 7 | 8.0 | 2.0 | 20 | 0.10 | 2.0 | 0.50 | Remainder |
| 8 | 8.0 | 2.0 | 20 | 2.0 | 2.0 | 0.50 | Remainder |
| 9 | 8.0 | 2.0 | 7.0 | 2.0 | 15 | 0.50 | Remainder |

For the inks according to Examples 1 to 9, an intermittent ejection property, redispersibility, and difficulty in the occurrence of offset and curling were evaluated. Table 2 shows the evaluation results of an intermittent ejection property, redispersibility, and difficulty in the occurrence of offset and curling for the inks according to Examples 1 to 9. In all of the inks according to Examples 1 to 9, the intermittent ejection property, redispersibility, and difficulty in the occurrence of offset and curling were evaluated to “Pass”.

TABLE 2

| | Evaluation results | | | | | | |
|---|---|---|---|---|---|---|---|
| | Intermittent | | | Offset | | Curling | |
| | ejection property | | | Evaluation | | Evaluation | |
| | Evaluation | | Redispersibility | value | | value | |
| Example | value | Evaluation | Evaluation | (%) | Evaluation | (mm) | Evaluation |
| 1 | 119 | A | A | 0.026 | A | 12 | A |
| 2 | 119 | A | A | 0.021 | A | 19 | A |
| 3 | 130 | A | A | 0.029 | A | 8 | A |
| 4 | 124 | A | A | 0.029 | A | 8 | A |
| 5 | 112 | A | A | 0.021 | A | 19 | A |
| 6 | 107 | A | A | 0.021 | A | 18 | A |
| 7 | 118 | A | A | 0.029 | A | 8 | A |
| 8 | 111 | A | A | 0.029 | A | 8 | A |
| 9 | 101 | A | A | 0.021 | A | 19 | A |

### Comparative Examples 1 to 9

In Comparative Examples 1 to 6, inks were prepared using the same raw materials as those in Examples 1 to 9 such that the composition shown in Table 3 was achieved. Note that the units of the numerical values shown in Table 3 are “mass %”. The ink according to Comparative Example 1 is different from the ink according to the above Example in that the content of the second water-soluble organic solvent is less than 0.10 mass %. The ink according to Comparative Example 2 is different from the ink according to the above Example in that the content of the second water-soluble organic solvent exceeds 2.0 mass %. The ink according to Comparative Example 3 is different from the ink according to the above Example in that the content of the first water-soluble organic solvent is less than 7.0 mass %. The ink according to Comparative Example 4 is different from the ink according to the above Example in that the content of the first water-soluble organic solvent exceeds 20 mass %. The ink according to Comparative Example 5 is different from the ink according to the above Example in that the content of the resin is less than 0.40 mass %. The ink according to Comparative Example 6 is different from the ink according to the above Example in that the content of the resin exceeds 5.0 mass %.

TABLE 3

| | Component | | | | | | |
|---|---|---|---|---|---|---|---|
| | | | Water-soluble | | | | |
| Comparative | | | organic solvent | | | | |
| Example | Pigment | Resin | First | Second | Third | Surfactant | Water |
| 1 | 8.0 | 5.0 | 7.0 | 0 | 15 | 0.50 | Remainder |
| 2 | 8.0 | 5.0 | 7.0 | 5.0 | 10 | 0.50 | Remainder |
| 3 | 8.0 | 2.0 | 5.0 | 1.0 | 20 | 0.50 | Remainder |
| 1 | 8.0 | 0.40 | 25 | 1.0 | 2.0 | 0.50 | Remainder |
| 5 | 8.0 | 0.10 | 7.0 | 1.0 | 2.0 | 0.50 | Remainder |
| 6 | 8.0 | 10 | 7.0 | 2.0 | 15 | 0.50 | Remainder |

In Comparative Example 7, an ink was prepared using the same raw materials as those in Examples 1 to 9 except for the first water-soluble organic solvent such that the composition shown in Table 4 was achieved. Note that the units of the numerical values shown in Table 4 are “mass %”. The ink according to Comparative Example 7 is different from the ink according to the above Example in that polyethylene glycol 1000 (PEG1000, a number average molecular weight: approximately 1000, manufactured by Tokyo Chemical Industry Co., Ltd.) is used instead of the first water-soluble organic solvent.

TABLE 4

| | Component | | | | | | |
|---|---|---|---|---|---|---|---|
| | | | Water-soluble | | | | |
| | | | organic solvent | | | | |
| Comparative | | | PEG | | | | |
| Example | Pigment | Resin | 1000 | Second | Third | Surfactant | Water |
| 7 | 8.0 | 2.0 | 7.0 | 1.0 | 15 | 0.50 | Remainder |

In Comparative Example 8, an ink was prepared using the same raw materials as those in Examples 1 to 9 except for the first water-soluble organic solvent such that the composition shown in Table 5 was achieved. Note that the units of the numerical values shown in Table 5 are “mass %”. The ink according to Comparative Example 8 is different from the ink according to the above Example in that diethylene glycol (DEG, a molecular weight of: 106.12, manufactured by Tokyo Chemical Industry Co., Ltd.) is used instead of the first water-soluble organic solvent.

TABLE 5

| | Component | | | | | | |
|---|---|---|---|---|---|---|---|
| | | | Water-soluble | | | | |
| Comparative | | | organic solvent | | | | |
| Example | Pigment | Resin | DEG | Second | Third | Surfactant | Water |
| 8 | 8.0 | 2.0 | 7.0 | 1.0 | 15 | 0.50 | Remainder |

In Comparative Example 9, an ink was prepared using the same raw materials as those in Examples 1 to 9 except for the resin such that the composition shown in Table 6 was achieved. Note that the units of the numerical values shown in Table 6 are “mass %”. The ink according to Comparative Example 9 is different from the ink according to the above Example in that the resin has a glass transition temperature of 40° C.

TABLE 6

| | Component | | | | | | |
|---|---|---|---|---|---|---|---|
| | | | Water-soluble | | | | |
| Comparative | | Resin | organic solvent | | | | |
| Example | Pigment | Tg40° C. | First | Second | Third | Surfactant | Water |
| 9 | 8.0 | 2.0 | 7.0 | 1.0 | 15 | 0.50 | Remainder |

For the inks according to Comparative Examples 1 to 9, an intermittent ejection property, redispersibility, and difficulty in the occurrence of offset and curling were evaluated. Table 7 shows the evaluation results of an intermittent ejection property, redispersibility, and difficulty in the occurrence of offset and curling for the inks according to Comparative Examples 1 to 9.

TABLE 7

| | Evaluation results | | | | | | |
|---|---|---|---|---|---|---|---|
| | Intermittent | | | Offset | | Curling | |
| | ejection property | | | Evaluation | | Evaluation | |
| Comparative | Evaluation | | Redispersibility | value | | value | |
| Example | value | Evaluation | Evaluation | (%) | Evaluation | (mm) | Evaluation |
| 1 | 108 | A | B | 0.021 | A | 20 | A |
| 2 | 91 | B | A | 0.020 | A | 19 | A |
| 3 | 111 | A | B | 0.019 | A | 22 | B |
| 4 | 131 | A | A | 0.032 | B | 7 | A |
| 5 | 132 | A | A | 0.032 | B | 8 | A |
| 6 | 88 | B | B | 0.021 | A | 19 | B |
| 7 | 95 | B | A | 0.024 | A | 17 | A |
| 8 | 121 | A | A | 0.020 | A | 22 | B |
| 9 | 121 | A | A | 0.032 | B | 13 | A |

As shown in Table 7, in the ink according to Comparative Example 1 in which the content of the second water-soluble organic solvent is less than 0.10 mass %, the redispersibility was evaluated to “Fail”. In the ink according to Comparative Example 2 in which the content of the second water-soluble organic solvent exceeds 2.0 mass %, the intermittent ejection property was evaluated to “Fail”. In the ink according to Comparative Example 3 in which the content of the first water-soluble organic solvent is less than 7.0 mass %, the redispersibility and difficulty in the occurrence of curling were evaluated to “Fail”. In the ink according to Comparative Example 4 in which the content of the first water-soluble organic solvent exceeds 20 mass %, the difficulty in the occurrence of offset was evaluated to “Fail”. In the ink according to Comparative Example 5 in which the content of the resin is less than 0.40 mass %, the difficulty in the occurrence of offset was evaluated to “Fail”. In the ink according to Comparative Example 6 in which the content of the resin exceeds 5.0 mass %, the intermittent ejection property, redispersibility, and difficulty in the occurrence of curling were evaluated to “Fail”. In the ink according to Comparative Example 7 in which a polyethylene glycol having a number average molecular weight larger than that of the first water-soluble organic solvent is used, the intermittent ejection property was evaluated to “Fail”. In the ink according to Comparative Example 8 in which diethylene glycol having a molecular weight smaller than that of the first water-soluble organic solvent is used, the difficulty in the occurrence of curling was evaluated to “Fail”. In the ink according to Comparative Example 9 in which the resin has a glass transition temperature of 40° C., the difficulty in the occurrence of offset was evaluated to “Fail”.

It should be understood by those skilled in the art that various modifications, combinations, sub-combinations and alterations may occur depending on design requirements and other factors insofar as they are within the scope of the appended claims or the equivalents thereof.

What is claimed is:

1. An ink, comprising:
a self-dispersing pigment;
0.40 mass % or more and 5.0 mass % or less of a resin having a glass transition temperature of −40° C. or more and 30° C. or less;
a first water-soluble organic solvent including a polyethylene glycol having a number average molecular weight of 200 or more and 600 or less;
a second water-soluble organic solvent including triethanolamine;
a third water-soluble organic solvent different from the first water-soluble organic solvent and the second water-soluble organic solvent; and
water,
a content of the first water-soluble organic solvent being 7.0 mass % or more and 20 mass % or less,
a content of the second water-soluble organic solvent being 0.10 mass % or more and 2.0 mass % or less.

2. The ink according to claim 1, further comprising
an acetylene glycol surfactant.
